(19) United States
(12) Patent Application Publication
(10) Pub. No.: US 2004/0197691 A1
(43) Pub. Date: Oct. 7, 2004

(54) Toner for electrostatic image development

(75) Inventors: Shinji Moriyama, Wakayama-shi (JP); Yoshihiro Fukushima, Wakayama-shi (JP); Hidenori Tachi, Wakayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Tokyo (JP)

(21) Appl. No.: 10/815,650

(22) Filed: Apr. 2, 2004

(30) Foreign Application Priority Data
Apr. 4, 2003 (JP) 2003-102283

(51) Int. Cl. G03G 9/09

(52) U.S. Cl. 430/108.4; 430/108.1; 430/109.4

(57) ABSTRACT

A toner for electrostatic image development, containing a resin binder; and a colorant containing a charcoal powder, wherein the charcoal powder has a volume-based median particle size (D₅₀) of 5.6 μm or less, and a coefficient of variation of 80% or less; a two-component developer containing the toner and a carrier; and a process for development of a two-component developer, including the step of applying the two-component developer to a developing device for two-component development. The toner can be suitably used for, for instance, the development of a latent image formed in electrophotography, electrostatic recording method, electrostatic printing method or the like.

### FIELD OF THE INVENTION

The present invention relates to a toner for electrostatic image development used for, for instance, the development of a latent image formed in electrophotography, electrostatic recording method, electrostatic printing method or the like.

### BACKGROUND OF THE INVENTION

In copy machines and printers in electrophotography, the development of a high-image quality including photo-reproducibility has been earnestly desired. Therefore, the use of a metal oxide as a black colorant in place of a low-resistivity carbon black has been proposed from the viewpoint of the development of high-image quality (Japanese Patent Laid-Open No. 2000-10344).

However, the degree of blackness of a metal oxide is lower than that of carbon black. Therefore, if the metal oxide is used in a large amount in order to obtain an image density of the same level as that obtained with a conventional toner containing carbon black, some drawbacks may be caused such as the amount of the toner consumed is increased due to the increase in the weight of the metal oxide, and toner scattering may be caused by the worsening of its chargeability.

Therefore, a toner containing a black colorant other than a carbon black and a metal oxide, the toner being capable of satisfying both a degree of blackness and a covering strength that can give a sufficient image density, and excellent image quality has been earnestly desired.

### SUMMARY OF THE INVENTION

The present invention relates to a toner for electrostatic image development, containing:

a resin binder; and

a colorant containing a charcoal powder, wherein the charcoal powder has a volume-based median particle size (D₅₀) of 5.6 μm or less, and a coefficient of variation of 80% or less.

### BRIEF DESCRIPTION OF THE DRAWINGS

FIG. 1 is a graph showing the relationship between the amount of toner adhered and the optical density for the toners obtained in Examples and Comparative Examples in Test Example 1.

FIG. 2 is an electron micrograph of the thin-line portion in the image obtained using the toner of Example 1 in Test Example 2.

FIG. 3 is an electron micrograph of the thin-line portion in the image obtained using the toner of Comparative Example 1 in Test Example 2.

FIG. 4 is an electron micrograph of the thin-line portion in the image obtained using the toner of Comparative Example 3 in Test Example 2.

### DETAILED DESCRIPTION OF THE INVENTION

The present invention relates to a toner for electrostatic image development, which is excellent in the degree of blackness and the covering strength, and capable of realizing excellent image quality.

These and other advantages of the present invention will be apparent from the following description.

One of the significant features of the present invention resides in that the toner contains a colorant containing a charcoal powder having a specified particle size distribution. Specifically, the volume-based median particle size (D₅₀) of the charcoal powder in the present invention is 5.6 μm or less, preferably from 0.1 to 5.6 μm, more preferably from 1.1 to 5.5 μm, even more preferably from 1.2 to 5.4 μm. Also, the coefficient of variation (CV) is 80% or less, preferably 70% or less, more preferably from 10 to 65%. When the volume-based median particle size of the charcoal powder is larger than 5.6 μm, it is difficult to contain the charcoal powder in the toner. Also, when the coefficient of variation exceeds 80%, the state of dispersion of the charcoal powder in the toner is inhomogeneous. Therefore, when these requirements are not satisfied, not only the degree of are blackness and the covering strength considerably lowered but also the chargeability is adversely affected, thereby resulting in the lowering of the image quality. Incidentally, in the present invention, the volume-based median particle size (D₅₀) refers to a particle size at which the cumulative volume frequency (%) based on the particle size from the small particle size side is 50%.

In the present invention, the charcoal powder includes wood-based charcoal powders, coconut-shell-based charcoal powders, and coal-based charcoal powders, and active carbons obtained by activation treatment of these charcoals, including mixtures thereof. Among them, the active carbons are preferable, wood-based and coconut-shell-based active carbons are more preferable, and the coconut-shell-based active carbons are even more preferable. The charcoal powder in the present invention is different from a carbon black obtained by a combination of thermal decomposition and incomplete combustion of hydrocarbons of natural gas, petroleum oil, creosote oil, and the like. Carbon black includes channel black, thermal lamp black, furnace black and the like.

The raw materials of the wood-based charcoal powder includes charcoal of red pine, Quercus acutissima, (evergreen) oak, Japanese cedar, cherry tree, pine, Japanese oak, and the like. Also, saw dust, wooden chips, and grass ash thereof may be used. The raw materials of the coconut-shell-based charcoal powder include the inner skin of the fruit of coconut and the like. The coal-based charcoal powder includes high-calorie coffee charcoal “HAIKAROTAN (trade name)”, oil carbon, a phenolic resin, rayon, acrylonitrile, petroleum pitch and the like.

Commercially available products of the wood-based and coconut-shell-based active carbons include “YP-17” (commercially available from KURARAY CHEMICAL CO., LTD.), “Taiko Activated Carbon V-O” (commercially available from Futamura Chemical Industries Co., Ltd.), “Shirasagi KA-2” (commercially available from TAKEDA CHEMICAL INDUSTRIES, LTD.) and the like.

The maximum diameter of the charcoal powder is preferably 1 mm or less, more preferably 0.5 mm or less.

The content of the charcoal powder is preferably from 1 to 40 parts by weight, more preferably from 3 to 30 parts by weight, even more preferably from 5 to 20 parts by weight, based on 100 parts by weight of the resin binder, from the viewpoint of the degree of blackness of the toner.

The resin binder in the present invention includes polyesters, styrene-acrylic resins, epoxy resins, polycarbonates, polyurethanes, hybrid resins in which two or more resin components are partially chemically bonded to each other, and the like, without being particularly limited thereto. Among them, from the viewpoints of the dispersibility and the transferability of the colorant, the polyester and the hybrid resin containing a polyester component and an addition polymer resin component such as a vinyl resin component are preferable, and the polyester is more preferable. The content of the polyester is preferably from 50 to 100% by weight, more preferably from 80 to 100% by weight, even more preferably 100% by weight, of the resin binder.

The polyester may be any of amorphous polyesters or crystalline polyesters. In the present invention, the amorphous polyester is preferable. In the present invention, the term “crystalline” means that the polyester has a ratio of the softening point to the maximum peak temperature of heat of fusion (softening point/maximum peak temperature of heat of fusion) of from 0.6 to 1.3, preferably from 0.9 to 1.2, more preferably greater than 1 and 1.2 or less. Also, the term “amorphous” means that the polyester has a ratio of the softening point to the maximum peak temperature of heat of fusion (softening point/maximum peak temperature of heat of fusion) of greater than 1.3 and 4 or less, preferably from 1.5 to 3.

The polyester is obtained by polycondensation of raw material monomers including an alcohol component containing dihydric or higher polyhydric alcohols with a carboxylic acid component containing dicarboxylic or higher polycarboxylic acid compounds.

The dihydric alcohol includes an alkylene (2 or 3 carbon atoms) oxide (average number of moles: 1 to 10) adduct of bisphenol A, such as polyoxypropylene(2.2)-2,2-bis(4-hydroxyphenyl)propane and polyoxyethylene(2.0)-2,2-bis(4-hydroxyphenyl)propane, ethylene glycol, propylene glycol, 1,6-hexanediol, bisphenol A, hydrogenated bisphenol A, and the like.

The trihydric or higher polyhydric alcohol includes sorbitol, 1,4-sorbitan, pentaerythritol, glycerol, trimethylolpropane and the like.

In addition, the dicarboxylic acid compound includes dicarboxylic acids such as phthalic acid, isophthalic acid, terephthalic acid, fumaric acid and maleic acid; a substituted succinic acid of which substituent is an alkyl group or alkenyl group having 1 to 20 carbon atoms; acid anhydrides thereof and alkyl (1 to 12 carbon atoms) esters thereof; and the like.

The tricarboxylic or higher polycarboxylic acid compound includes 1,2,4-benzenetricarboxylic acid (trimellitic acid), acid anhydrides thereof, alkyl (1 to 12 carbon atoms) esters thereof, and the like.

Incidentally, the alcohol component and the carboxylic acid component may appropriately contain a monohydric alcohol and a monocarboxylic acid compound from the viewpoints of adjustment of the molecular weight and improvement in the offset resistance.

The polyester can be prepared by, for instance, polycondensation of the alcohol component and the carboxylic acid component under reduced pressure at a temperature of 180° to 250° C. in an inert gas atmosphere, in the presence of an esterification catalyst as desired.

The amorphous polyester has a softening point of preferably from 80° to 165° C. and a glass transition temperature of preferably from 50° to 85° C. Also, the amorphous polyester has an acid value of preferably from 0.5 to 60 mg KOH/g, from the viewpoints of the dispersibility and the transferability of the colorant. Even more preferably, in the case of a positively chargeable toner, the acid value is preferably from 0.5 to 20 mg KOH/g, more preferably from 3 to 10 mg KOH/g. Also, in the case of a negatively chargeable toner, the acid value is preferably from 10 to 60 mg KOH/g. The hydroxyl value is preferably from 1 to 60 mg KOH/g, more preferably from 5 to 60 mg KOH/g, even more preferably from 10 to 50 mg KOH/g.

Further, it is preferable that the polyester contains a high-softening point polyester and a low-softening point polyester. It is desired that the softening point of the high-softening point polyester is 120° C. or higher and 170° C. or lower, preferably from 130° to 170° C., more preferably from 135° to 155° C., and that the softening point of the low-softening point polyester is from 80° C. or higher and less than 120° C., preferably from 90° to 115° C., more preferably from 95° to 110° C.

The difference in softening point between the high-softening point polyester and the low-softening point polyester is preferably 10° C. or more, more preferably from 20° to 80° C., even more preferably from 30° to 60° C.

Incidentally, in the present invention, it is preferable that both of the high-softening point polyester and the low-softening point polyester are an amorphous polyester, and that the difference between the softening point and the glass transition temperature is preferably 20° C. or more, more preferably from 30° to 100° C.

The softening point and the glass transition temperature of the polyester can be adjusted by the monomer composition, the cross-linking degree, the molecular weight, and the like.

The weight ratio of the high-softening point polyester to the low-softening point polyester (high-softening point polyester/low-softening point polyester) is preferably from 5/95 to 95/5, more preferably from 20/80 to 90/10.

Incidentally, each of the high-softening point polyester and the low-softening point polyester may be a mixture of a plurality of polyesters.

The hybrid resin may be obtained by using two or more resins as raw materials, or it may be obtained by using one resin and raw material monomers of the other resin. Further, the hybrid resin may be obtained from a mixture of raw material monomers of two or more resins. In order to efficiently obtain a hybrid resin, those obtained from a mixture of raw material monomers of two or more resins are preferable.

It is preferable that the toner of the present invention contains a charge control agent. The kind of the charge control agent is not particularly limited, and a quaternary ammonium salt-type charge control agent is preferable.

The quaternary ammonium salt contained as the charge control agent is preferably a compound represented by the formula (I):

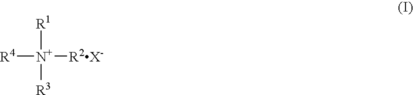

wherein each of R¹ to R⁴, which may be identical or different, is a lower alkyl group having 1 to 8 carbon atoms which may be substituted by a halogen atom, an alkyl group or alkenyl group having 8 to 22 carbon atoms, or an aryl group or aralkyl group having 6 to 20 carbon atoms; and X⁻ is an anion.

In the present invention, from the viewpoints of giving a toner more stable triboelectric chargeability and more improved fixing ability, it is preferable that each of R¹ to R⁴ is a lower alkyl group having 1 to 4 carbon atoms which may be substituted by a halogen atom, an alkyl group having 12 to 18 carbon atoms, phenyl group or benzyl group, and that X⁻ is preferably an aromatic sulfonate ion such as toluenesulfonate ion or hydroxynaphthalenesulfonate ion; an aromatic carboxylate ion; molybdate ion; tungstate ion; a halogen ion or hydroxide ion, more preferably the aromatic sulfonate ion, the aromatic carboxylate ion and the molybdate ion.

Commercially available products containing the compound represented by the above-mentioned formula (I) include “TP-415” (commercially available from Hodogaya Chemical Co., Ltd.), “BONTRON P-51” (commercially available from Orient Chemical Co., Ltd.), “Copy Charge PSY” (commercially available from Clariant (Japan) K.K.), and the like.

In the present invention, a compound represented by the formula (Ia):

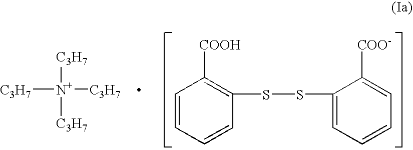

is preferable. Among the above-mentioned commercially available products, “COPY CHARGE PSY” (commercially available from Clariant (Japan) K.K.) corresponds to a commercially available product containing the compound.

The content of the quaternary ammonium salt is preferably from 0.01 to 5 parts by weight, more preferably from 0.05 to 3 parts by weight, even more preferably from 0.1 to 2 parts by weight, based on 100 parts by weight of the resin binder.

In addition, a charge control agent other than the quaternary ammonium salt may be used, as occasion demands. Even more preferably, it is preferable that a nigrosine dye is used together with the quaternary ammonium salt from the viewpoint of the balance of the triboelectric charges with the quaternary ammonium salt. Incidentally, it is preferable that the charge control agent is internally added in the resin binder, or alternatively, the charge control agent may be externally added to the toner surface.

Further, it is preferable that a low-melting point wax is contained in the toner of the present invention from the viewpoints of the low-temperature fixing ability and the offset resistance. The melting point of the low-melting point wax is preferably from 50° to 120° C., more preferably from 60° to 120° C. The low-melting point wax is preferably at least one selected from the group consisting of carnauba wax, montan ester wax, rice wax and candelilla wax, including mixtures thereof, and more preferably carnauba wax, from the viewpoints of the dispersibility in the resin binder and the low-temperature fixing ability.

The content of the low-melting point wax is preferably from 0.1 to 10 parts by weight, more preferably from 0.5 to 5 parts by weight, even more preferably from 1 to 3 parts by weight, based on 100 parts by weight of the resin binder, from the viewpoints of the low-temperature fixing ability and the offset resistance.

In addition, a releasing agent other than the low-melting point wax may be contained in the toner, as occasion demands. Incidentally, it is preferable that the releasing agent is internally added in the resin binder, or alternatively, the releasing agent may be externally added to the toner surface.

The toner of the present invention may contain a magnetic powder, from the viewpoint of suppressing toner scattering. The magnetic powder includes alloys such as magnetite, hematite and ferrite; ferromagnetic metal powders of iron, cobalt and nickel; and the like. It is preferable that the content of the magnetic powder is from 0.5 to 10 parts by weight based on 100 parts by weight of the resin binder.

Furthermore, the toner of the present invention may contain an additive such as a fluidity improver, an electric conductivity modifier, an extender, a reinforcing filler such as a fibrous substance, an antioxidant, an anti-aging agent, and a cleanability improver appropriately by internal or external addition.

The process for preparing the toner of the present invention may be any of conventionally known methods such as a kneading-pulverization method, an emulsion phase-inversion method and polymerization method, and the kneading-pulverizing method is preferable from the viewpoint of easily preparing the toner. For instance, in a case of a pulverized toner prepared by kneading and pulverization method, the method includes the step of homogeneously mixing a resin binder, a colorant, and the like in a mixer such as a Henschel mixer, thereafter melt-kneading with a closed kneader, a single-screw or twin-screw extruder or the like, cooling, pulverizing and classifying the product. The volume-average particle size of the toner is preferably from 3 to 15 μm, more preferably from 7 to 12 μm.

The dielectric loss tangent (tan Δ) of the toner is preferably from 0.001 to 0.01, more preferably from 0.002 to 0.006, from the viewpoint of the printed image quality, especially the background fogging, which is affected by the dispersibility of the charcoal powder in the toner. The dielectric loss tangent (tan Δ) of the toner shows a ratio of capacitance to conductance, which is used as an index for the degree of dispersion of the internal additive in the toner. Specifically, it can be determined that the smaller the value of tan Δ, the higher the degree of dispersion of the internal additive. The tan Δ of the toner can be adjusted by changing the kinds, the amounts and the pre-mixing time of the raw materials, various conditions in the kneading step, and the like.

The toner of the present invention can be used alone as a developer, in a case where the fine magnetic material powder is contained. Alternatively, in a case where the fine magnetic material powder is not contained, the toner may be used as a nonmagnetic monocomponent developer, or the toner can be mixed with a carrier and used as a two-component developer. The toner of the present invention is preferably used as a toner for the two-component developer because it is excellent in durability.

The process for development for a two-component developer of the present invention includes the step of applying the two-component developer of the present invention to a developing device for two-component development.

The toner of the present invention has benefits such as a high degree of blackness, little toner scattering, and excellent fine halftone reproducibility, and can prevent causation of flare. Therefore, the toner of the present invention can be suitably used not only for charged area development but also for reversal development.

Further, since the toner of the present invention has a resistance similar to those of colorants such as yellow, cyan and magenta, the toner is suitably used in the formation of full-color fixed images.

### EXAMPLES

The following examples further describe and demonstrate embodiments of the present invention. The examples are given solely for the purposes of illustration and are not to be construed as limitations of the present invention.

[Softening Point of Resin]

The softening point refers to a temperature at which a half of the resin flows out, when measured by using a flow tester of the “koka” type “CFT-500D” (commercially available from Shimadzu Corporation) (sample: 1 g, rate of raising temperature: 6° C./min, load: 1.96 MPa, and nozzle: 1 mm φ×1 mm).

[Glass Transition Temperature of Resin]

The glass transition temperature of a resin is determined using a differential scanning calorimeter “DSC 210” (commercially available from Seiko Instruments, Inc.) while raising the temperature at a rate of 10° C./min.

[Particle Size Distribution of Toner and Charcoal Powder]

The volume-based median particle size (D₅₀) and the coefficient of variation (CV) [standard deviation/D₅₀×100] are determined with a Coulter counter “Coulter Multisizer II” according to the following methods.

i) Multisizer Setup

P1. SETUP MENU

ORIFICE DIAMETER: 100 μm

ORIFICE LENGTH: 75.00 μm

SET UP: MANUAL

ANALYSIS: SAMPLE

ii) Preparation of Sample Solution

A 100-ml beaker charged with 5 ml of a dispersion and 10 mg of a sample is placed in an ultrasonic cleaning device to allow the sample to disperse in the dispersion for 30 seconds. Further, 25 ml of isotone is added to the beaker, and the beaker is subjected to ultrasonic cleaning for 60 seconds.

iii) Determination

Eighty milliliters of isotone is added to another beaker, and the beaker is set to a sample stand. The knob of “STIRRER CONTROL” is set at 2.5, and bubbles in the beaker placed in the sample stand are removed in advance.

Within 30 seconds after the preparation of the sample solution, the sample solution is added little by little using a dropping pipette to the beaker set to the sample stand. During this procedure, care is taken not to cause bubbles to be introduced in the solution.

With confirming the amount of the sample solution in the concentration graph on the screen of the Multisizer, the amount of the sample solution is adjusted so that the concentration graph shows from 9 to 15%.

When the concentration graph shows from 9 to 15%, an outer door is closed and the RESET key is pressed.

The dial of “FILL CLOSE” is slowly turned right to a vertical position. The bubbles at the aperture are briefly degassed, and then the dial is again slowly turned right to a horizontal position.

The START key is pressed to start the determination. The determination is automatically terminated when the N number is 30000.

[Dielectric Loss Tangent (tan Δ) of Toner]

Five grams of a toner is supplied in a press die for tableting having an inner diameter of 59 mm so that the toner surface is even. The die is set in an electric sample-molding machine (C/N: 9302/30, commercially available from Maekawa Shiken-ki), and a pressure of 10 tons by the scale on a Bourdon's tube pressure gauge provided in the machine is applied for 10 seconds, to give a toner pellet having a diameter of 59 mm and a thickness of about 1.7 mm.

The dielectric loss tangent of the resulting toner pellet is determined at 1 kHz under the environment of a temperature of 25° C. and a humidity of 50%, using a precision LCR meter; HP 4284 and an electrode for dielectric determination; HP 16451 B (electrode used: Electrode A) (both commercially available from YOKOGAWA Hewlett-Packard).

[Saturation Magnetization of Carrier]

(1) A carrier is filled in a plastic case with a lid with tapping, the case having an external diameter of 7 mm (internal diameter: 6 mm) and a height of 5 mm. The mass of the carrier is determined from the difference of the weight of the plastic case and the weight of the plastic case filled with the carrier.

(2) The plastic case filled with the carrier is set in a sample holder of a magnetic property measuring device “BHV-50H” (V. S. MAGNETOMETER) commercially available from Riken Denshi Co., Ltd. The saturation magnetization is determined by applying a magnetic field of 79.6 kA/m, with vibrating the plastic case using the vibration function. The value obtained is calculated as saturation magnetization per unit mass, taking into consideration the mass of the filled carrier.

Resin Preparation Example 1

The amount 2450 g of a propylene oxide (average number of moles: 2.2 moles) adduct of bisphenol A, 975 g of an ethylene oxide (average number of moles: 2.2 moles) adduct of bisphenol A, 259 g of isododecenylsuccinic acid, 961 g of terephthalic acid, 278 g of trimellitic anhydride and 9.8 g of dibutyltin oxide (esterification catalyst) were reacted under a nitrogen gas stream at 230° C. for 8 hours. Thereafter, the pressure in the system is reduced to 8.3 kPa, and the components were reacted until the softening point determined according to ASTM D36-86 reached about 150° C. The resulting resin is referred to as Resin A. Resin A had a softening point of 148° C., a glass transition temperature of 62° C., and an acid value of 8 mg KOH/g.

Resin Preparation Example 2

The amount 3087 g of a propylene oxide (average number of moles: 2.2 moles) adduct of bisphenol A, 59 g of an ethylene oxide (average number of moles: 2.2 moles) adduct of bisphenol A, 994 g of terephthalic acid, 33 g of trimellitic anhydride, 4.5 g of t-butylcatechol and 8.9 g of dibutyltin oxide (esterification catalyst) were reacted under a nitrogen gas stream at 230° C. for 6 hours. Thereafter, the reaction mixture was cooled to 180° C., and 298 g of fumaric acid was added thereto. The temperature was raised from 180° C. to 210° C. at 10° C./hour, and thereafter the components were reacted at 210° C. and 8.3 kPa until the softening point determined according to ASTM D36-86 reached about 100° C. The resulting resin is referred to as Resin B. Resin B had a softening point of 104° C., a glass transition temperature of 61° C., and an acid value of 11 mg KOH/g.

Preparation Example of Carrier

Magnesium oxide was formulated with hematite so as to have a content of magnesium of 3.0% by weight. To 100 parts by weight of the resulting mixture were added 1.5 parts by weight of a binder (polyvinyl alcohol) and 0.5 parts by weight of a dispersant, and water was added thereto so as to give a slurry concentration of 50%. The components were subjected to mixing and wet-pulverization for 1 hour with an attritor commercially available from MITSUI MINING & SMELTING CO., LTD., to give a slurry.

The slurry was granulated and dried with a spray-drier, and then sintered at about 1500° C. in an electric oven under nitrogen gas atmosphere, and the sintered product was classified with a vibrating sieve, to give a core material of a carrier.

Methyl ethyl ketone was added to 6.5 parts by weight of a fluororesin “HYLAR 301 F” (commercially available from Ausmond) and 3.5 parts by weight of an acrylate resin “Dianal BR-80” (commercially available from Mitsubishi Rayon Co., Ltd.), based on 1000 parts by weight of the resulting core material, to give a resin solution for coating the core material. This resin solution was spray-coated on the above-described core material using a fluidized-coating device. Thereafter, a heat treatment was carried out at 100° C. for 60 minutes in the fluidized bed, to give a carrier A having an average particle size of 110 μm. The saturation magnetization of the carrier A was 52.5 Am²/kg.

### Examples 1 and 2 and Comparative Examples 1 to 3

Fifty parts by weight of Resin A, 50 parts by weight of Resin B, and 12 parts by weight of a charcoal powder as shown in Table 1, 2 parts by weight of a charge control agent “BONTRON N-01” (commercially available from Orient Chemical Co., Ltd.), 0.2 parts by weight of a charge control agent “Copy Charge PSY” (commercially available from Clariant (Japan) K.K.), 1 part by weight of a polypropylene wax “Viscol 660P” (commercially available from SANYO CHEMICAL INDUSTRIES, LTD.) and 1.5 parts by weight of “Carnauba Wax C1” (commercially available from K.K. Kato Yoko) were pre-mixed with a Henschel Mixer. Thereafter, the mixture was melt-kneaded with a twin-screw kneader, cooled, pulverized and classified, to give a powder having a volume-average particle size of 10 μm.

To 100 parts by weight of the resulting powder, 0.3 parts by weight of a hydrophobic silica “HVK 2150” (commercially available from Clariant (Japan) K.K.) were mixed and adhered with a Henschel Mixer, to give a toner. The dielectric loss tangent (tan Δ) of each toner is shown in Table 1.

Further, 39 parts by weight of the resulting toner and 1261 parts by weight of the Carrier A were mixed with a Nauta Mixer, to give a two-component developer.

### Example 3

The same procedures were carried out as in Example 1 except that as resin binders Resin B was not used and the amount of Resin A used was changed to 100 parts by weight, to give a two-component developer.

### Example 4

The same procedures were carried out as in Example 1 except that as resin binders Resin A was not used and the amount of Resin B used was changed to 100 parts by weight, to give a two-component developer.

Test Example 1

(1) A two-component developer is loaded in a printer for reversal development “Infoprint 4000 IS1” (commercially available from IBM Japan, Ltd., linear speed: 1066 mm/sec, resolution: 240 dpi, number of magnet rollers: 3, selenium photoconductor, contact development). A printing pattern in which there are two black solid parts, each being a square of 2.5 cm per side, per sheet is selected, the number of print is set to 20, and the contrast is set to 1.

(2) Printing is started and discontinued after 5 sheets have been printed out.

(3) Two fixed images sequentially obtained in the printing and two unfixed images remaining on the tension arm are picked as a sample.

(4) Preparation for printing is made again, the contrast is set to 4 or 7, and images are picked as a sample in the same manner as the case where the contrast is 1.

(5) The optical density of the fixed image at each contrast is determined according to the methods described below.

(6) The four black solid parts (2 parts per sheets; 2 sheets) in the unfixed images at each contrast are cut out by scissors. The weight of each of the four black solid parts is measured and the total (A) is determined.

(7) After the weight measurement, the toner on the unfixed images is blown off. The weight of each paper after toner removal is measured and the total (B) for 4 sheets of paper is determined.

(8) The amount (g/25 cm²) of toner adhered is determined from the value (A)-(B).

[Optical Density (OD)]

The optical density is determined for 5 points in each one of the 4 black solid parts, each being a square of 2.5 cm per side, using “GRETAG SPM 50” (Gretag, absolute white calibration; Pol filter, measured scope: 2° C., illumination type: +, Wbase: Abs, Dstd: DIN NB, Sample mode). The optical densities of a total of 20 points are determined, and then the average value is calculated.

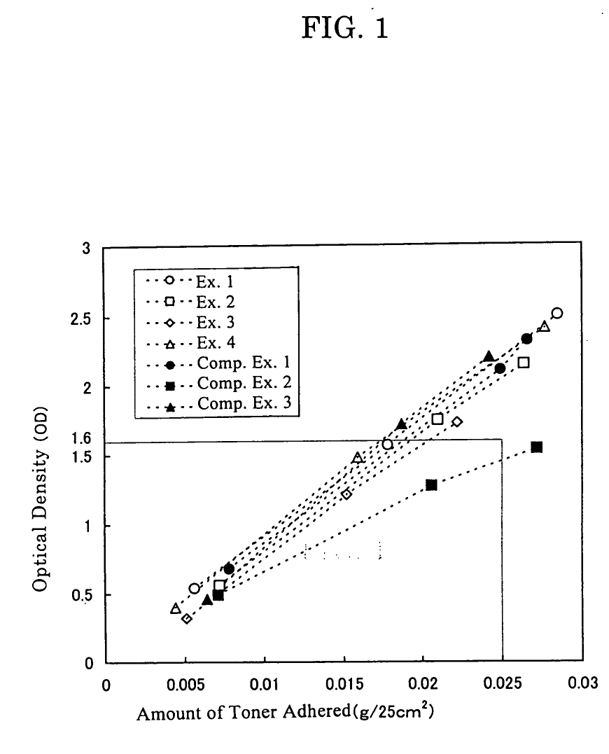

The relationship between the amount of toner adhered and the optical density of the fixed image is shown in FIG. 1. The allowable level for the amount of toner adhered against the optical density is an amount of toner adhered of 0.025 g/25 cm² or less when the OD is 1.6. When the adhered amount exceeds this value, the fixing ability of the toner is lowered.

Test Example 2

A two-component developer was loaded in the same machine as in Test Example 1. A printing pattern containing four solid images, a square of 2.5 cm per side, with a blackened ratio of 8%, was printed with a contrast of 7 using a continuous feeding paper having a size of 11 inch×18 inch. The background fogging and the thin-line reproducibility were determined or evaluated according to the following methods. The results are shown in Table 1.

[Background Fogging (BG)]

A non-image bearing portion of a paper before printing (Yb) and that of a paper after printing (Ya) are measured by using “Model 938 Spectrodensitometer” (X-Rite, aperture; 20 mm, Measurement mode; Yxy, light source; D₆₅, scope angle; 10 degrees), and the BG value is determined by the following equation:

BG Value=Yb−Ya.

The allowable level for the background fogging is 0.7 or less. When the value exceeds 0.7, the background fogging by the toner can be visually recognized, and the image quality is significantly deteriorated.

[Thin-Line Reproducibility]

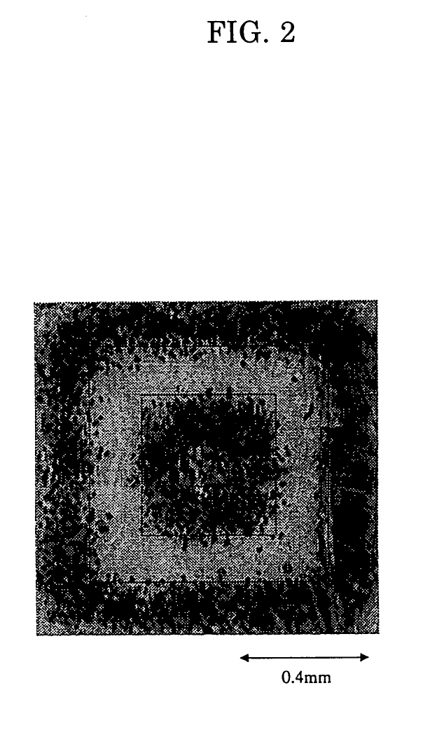

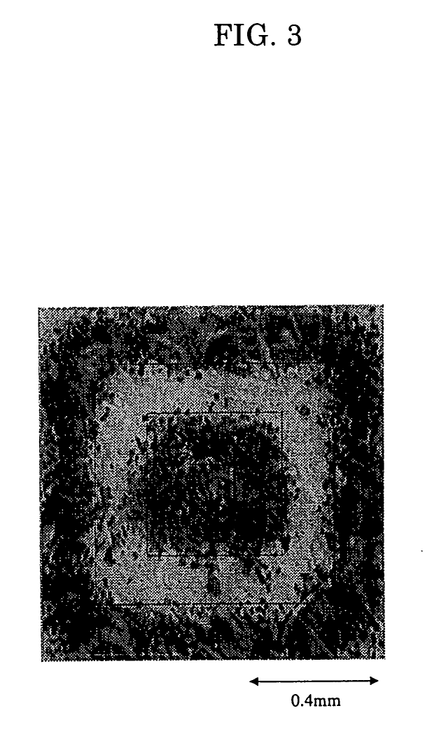

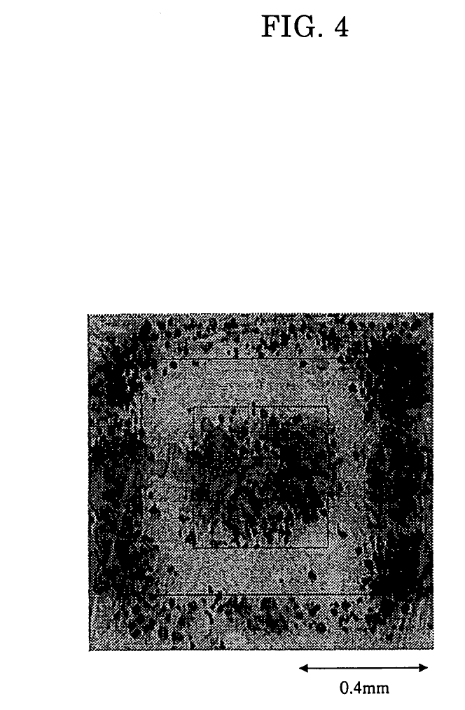

The thin-line reproducibility was evaluated by visually observing the printed state of a thin-line portion in the printing pattern. The electron micrographs of the thin-line portions in the images obtained using the toners of Example 1, Comparative Example 1 and Comparative Example 3 are shown in FIGS. 2 to 4.

TABLE 1

| | Black | Charcoal Powder | | | | Thin-Line |
|---|---|---|---|---|---|---|
| | Colorant | D₅₀ | CV | Tan δ | BG | Reproducibility |
| Ex. 1 | KA-2 | 3.81 | 60.3 | 0.00262 | 0.37 | Good |
| Ex. 2 | YP-17 | 5.16 | 59.9 | 0.00290 | 0.50 | Good |
| Ex. 3 | KA-2 | 3.81 | 60.3 | 0.00221 | 0.31 | Good |
| Ex. 4 | KA-2 | 3.81 | 60.3 | 0.00496 | 0.61 | Good |
| Comp. | SA1000 | 5.59 | 88.2 | 0.02002 | 1.19 | Poor |
| Ex. 1 | | | | | | |
| Comp. | FAC-10 | 20 | 78.3 | 0.00279 | 0.81 | Poor |
| Ex. 2 | | | | | | |
| Comp. | Regal | — | — | 0.00406 | 0.30 | Poor |
| Ex. 3 | 330R | | | | | |

Note)
KA-2 (Shirasagi KA-2): coconut shell-based activated carbon, commercially available from TAKEDA CHEMICAL INDUSTRIES, LTD.
YP-17: coconut shell-based active carbon, commercially available from KURARAY CHEMICAL CO., LTD.
SA1000 (Taiko Activated Carbon SA 1000): wood-based activated carbon, commercially available from Futamura Chemical Industries Co., Ltd.
FAC-10 (Shirasagi FAC-10): wood-based activated carbon, commercially available from TAKEDA CHEMICAL INDUSTRIES, LTD.
Regal 330R: carbon black, commercially available from Cabot Corporation

It can be seen from the results in Table 1 and FIG. 1 that the toners of Examples 1 to 4 have low occurrences of background fogging and excellent thin-line reproducibility, so that the image quality is excellent. In addition, as for the amount of the toner adhered with respect to image density, since the desired image density is secured with a smaller amount of toner adhered, it can be seen that sufficient degree of blackness and covering strength are obtained by the toners of Examples 1 to 4 each of which contains the charcoal powder. Further, for each of the toners of Examples 1 to 3, since the tan Δ, which is used as an index for dispersibility of the additives in the toner, is low, the dispersibility of the charcoal powder in each of the toners of Examples 1 to 3 is high, whereby it is deduced that still further improvement in the image quality is realized. Moreover, in the case of Example 4 where a low-softening point resin is used, the worsening in the dispersibility of the additives in the toner due to insufficient kneading strength is likely to be caused. However, by using a specified active carbon, the toner of Example 4 realizes excellent thin-line reproducibility with lower background fogging.

In contrast, in the toners of Comparative Example 1 and Comparative Example 2 each of which contains a charcoal powder having a volume-based median particle size and a coefficient of variation outside the desired ranges, it is deduced that there exists a charcoal powder which is not contained in the toner, whereby the background fogging is highly apparent to an extent that can be visually recognized, thereby deteriorating the image quality. Especially, in the toner of Comparative Example 1, since the value of tan Δ is high and the dispersibility of the charcoal powder is poor, it is deduced that the triboelectric charges of the toner is adversely affected, so that there is a higher occurrence of background fogging. Also, in the toner of Comparative Example 2, it can be seen that the amount of toner adhered with respect to image density is high so that the degree of blackness and the covering strength are insufficient.

Also, in the toner of Comparative Example 3 containing a carbon black, the thin-line reproducibility is poor, even though substantially no background fogging takes place and excellent results are obtained for the amount of toner adhered.

According to the present invention, there can be provided a toner for electrostatic image development, which is, for example, excellent in the degree of blackness and the covering strength, and capable of realizing excellent image quality.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A toner for electrostatic image development, comprising:
a resin binder; and
a colorant comprising a charcoal powder, wherein the charcoal powder has a volume-based median particle size (D₅₀) of 5.6 μm or less, and a coefficient of variation of 80% or less.

2. The toner according to claim 1, wherein the resin binder comprises a polyester.

3. The toner according to claim 1, wherein the charcoal powder is contained in an amount of from 1 to 40 parts by weight based on 100 parts by weight of the resin binder.

4. The toner according to claim 1, wherein the charcoal powder is at least one member selected from the group consisting of wood coal-based charcoal powders, coconut-shell-based charcoal powders, and mixtures thereof.

5. The toner according to claim 1, wherein the toner has a dielectric loss tangent of 0.01 or less.

6. The toner according to claim 1, wherein the resin binder comprises a high-softening point polyester having a softening point of 120° C. or more and 170° C. or less, and a low-softening point polyester having a softening point of 80° C. or more and less than 120° C.

7. The toner according to claim 1, further comprising a low-melting point wax having a melting point of from 50° to 120° C.

8. The toner according to claim 7, wherein the low-melting point wax is at least one member selected from the group consisting of carnauba wax, montan ester wax, rice wax, candelilla wax, and mixtures thereof.

9. A two-component developer comprising the toner of claim 1 and a carrier.

10. A process for development of a two-component developer, comprising applying the two-component developer of claim 9 to a developing device for two-component development.
